(19) United States
(12) Patent Application Publication
(10) Pub. No.: US 2022/0309793 A1
(43) Pub. Date: Sep. 29, 2022

(54) System for determining the position of movable dummy elements

(71) Applicant: 4ACTIVESYSTEMS GMBH, Traboch (AT)

(72) Inventors: Reinhard Hafellner, Spielberg (AT); Martin Fritz, Kobenz (AT)

(73) Assignee: 4ACTIVESYSTEMS GMBH, Traboch (AT)

(21) Appl. No.: 17/616,834

(22) PCT Filed: Jun. 4, 2020
(86) PCT No.: PCT/EP2020/065532

§ 371 Date: Dec. 6, 2021

(30) Foreign Application Priority Data
Jun. 7, 2019 (DE) 10 2019 115 535.5

(51) Int. Cl. G06V 20/54; G06V 20/58; G06V 10/60; G06V 20/40; G01C 21/20

(52) U.S. Cl. CPC G06V 20/54; G06V 20/58; G06V 10/60; G06V 20/41; G01C 21/206; G06V 2201/08

(57) ABSTRACT

The present invention relates to a system for determining the position of movable dummy elements in a roofed test site, in particular in a hall. The system comprises a camera configured to record an image of a monitoring area of the roofed test site, a movable dummy element which is movable through the monitoring area, the dummy element comprising a marker element arranged to be visible on the recorded image of the monitoring area, and a position determination unit coupled to the camera and configured to determine the position of the marker element in the monitoring area based on the recorded image.

This application is the U.S. national phase of International Application No. PCT/EP2020/065532 filed Jun. 4, 2020 which designated the U.S. and claims priority to German Patent Application No. 10 2019 115 535.5 filed Jun. 7, 2019, the entire contents of each of which are hereby incorporated herein by reference.

### TECHNICAL FIELD

Embodiments of the present invention in particular relate to a system for determining the position of movable dummy elements in a roofed test site (covered test area).

### BACKGROUND

Nowadays, it is necessary to reproduce and simulate complex traffic situations for testing driver assistance systems, in particular from the point of view of autonomous driving. For this purpose, a plurality of different dummy elements is moved in relation to each other and controlled, in particular, based on GPS data. Therefore, the test runs have to take place outdoors to receive GPS data.

### DESCRIPTION OF THE INVENTION

There may be a need to perform a position determination in a roofed test site.

This need may be met by the features of the independent claim.

According to a first aspect, a system for determining the position of movable dummy elements in a roofed test site, in particular in a hall, is provided. The system comprises a camera configured (arranged) to record an image (picture) of a monitoring area (surveillance area) of the roofed test site and a movable dummy element which is movable through the monitoring area. The system further comprises a marker element movable with the dummy element so as to be visible on the recorded image of the monitoring area, and a position determination unit coupled to the camera and configured to determine the position of the marker element in the monitoring area based on the recorded image.

According to a further exemplary embodiment, a method for operating the above-described system for determining the position of movable dummy elements in a roofed test site, in particular in a hall, is described. According to the method, the position of the marker element in the monitoring area is determined based on the recorded image.

According to an exemplary embodiment, the marker element is arranged on the dummy element. The marker element is arranged on the dummy element such that it is visible on the recorded image of the monitoring area.

According to an exemplary embodiment, the system further comprises a further (stationary and non-movable) marker element which is arranged stationary in the monitoring area in such a way that it is visible on the recorded image of the monitoring area. The position of the stationary marker element is predefined and known, so that, for example, the recorded image of the monitoring area may be calibrated using the stationary marker element.

According to an exemplary embodiment, the position determination unit is configured to overlay a virtual grid over the image, wherein each grid field of the grid is indicative of a particular position in the monitoring area.

According to an exemplary embodiment, a grid field is smaller than 9 cm², in particular smaller than 4 cm², further in particular smaller than 2 cm². If the dummy element is thus located in a grid point, the position of the dummy element may conversely be determined on the basis of the knowledge of the grid point.

According to an exemplary embodiment, the camera is configured to record a further image after a certain time offset after the image, wherein the position determination unit is configured to determine a movement speed and a movement direction of the marker element based on the recorded image and the further image.

According to an exemplary embodiment, the system comprises a further camera which is configured to record an image of a further monitoring area of the roofed test site, wherein the position determination unit is coupled to the further camera and is configured to determine the position of the marker element in the further monitoring area based on the recorded image of the further image.

According to an exemplary embodiment, the further monitoring area is positioned adjacent to the monitoring area, wherein at least one edge region of the monitoring area and a further edge region of the further monitoring area overlap.

According to an exemplary embodiment, the system comprises a further movable dummy element which may be moved through the monitoring area and/or the further monitoring area, the further dummy element comprising a further marker element arranged to be visible on the recorded image of the monitoring area or the image of the further monitoring area.

According to an exemplary embodiment, the position determination unit is configured to determine a collision point of the dummy element with the further dummy element.

According to an exemplary embodiment, the dummy element is a two-wheeler, a motorcycle or a bicycle, a motor vehicle, in particular a passenger car or a truck, a human dummy or an animal dummy.

According to an exemplary embodiment, the system comprises a movable platform, wherein the dummy element is arranged on the movable platform.

According to another exemplary embodiment, the marker element is arranged on the movable platform.

According to an exemplary embodiment, the system comprises at least one illumination means for illuminating the monitoring area with electromagnetic radiation, wherein the camera is configured to record, in the image, the electromagnetic radiation by means of which the illumination means illuminates the monitoring area.

According to an exemplary embodiment, the electromagnetic radiation is generated in the visible spectrum with a wavelength of 380 to 750 nm, or the electromagnetic radiation is generated in the non-visible spectrum, in particular as infrared radiation, ultraviolet radiation or terahertz radiation. According to an exemplary embodiment, the marker element is fluorescent.

According to an exemplary embodiment, the marker element is an illuminant (light emitting device) comprising in particular an LED generating visible light or non-visible light recordable by the camera.

In particular, the marker element is configured to generate or reflect visible and/or invisible light. The camera is configured to measure visible or invisible light, so that this may be represented on the image, in particular in transformed form. Thus, for example, the roofed test site may be darkened in order to carry out night tests.

According to another exemplary embodiment, the camera has a resolution of less than 10 megapixels, wherein the camera is particularly configured to record an image in 4:3 format. The lower the number of pixels and the simpler the format, the less amount of data has to be processed. A smaller amount of data is advantageous in terms of the speed of the image processing and thus the position determination.

In other words, a, resolution with a short latency period is desired to calculate a position and to transmit control signals. As an example, the camera has 10 megapixels with a 4:3 format and a resolution of 3651×2739. For a hall with a floor area of 160 m×50 m, (10 MP=>36 m×27 m=>5×2) approximately 10 cameras are required.

For a camera of a full HD format 1280×720 and for a hall of a floor space (10 MP=>12 m×7 m=>13×8), there are distributed already 104 cameras, e.g. on the hall ceiling. Cameras with short response times and lower resolutions are used. Furthermore, different types of cameras may be used, e.g. a first camera for fast initial recognition positioning and a second camera, which interprets an exact position.

Thus, according to an exemplary embodiment, a camera having a higher resolution and a camera having a lower resolution may be used to record images of the common monitoring area. For example, the higher resolution second camera may be used to record a resolved image to determine the exact position of the dummy element. At the same time, the less high-resolution first camera may be used to record low-resolution images at short intervals to obtain directional and motion information of the dummy element. Thus, the position determination unit may quickly process the accurate position data and the direction and motion information so that an accurate motion profile of the dummy element may be calculated without delay. In particular, since the low-resolution images generate a smaller amount of data, a plurality of such non-resolution images may be rapidly recorded and rapidly processed. Thus, a change in direction or speed of the dummy element may be quickly detected and measured.

According to an exemplary embodiment, the marker element has a round (circular) or rectangular circumference, wherein the marker element has particular two color areas, in particular white and black.

According to an exemplary embodiment, the marker element comprises a direction indicator which indicates an orientation of the object. The defined orientation of the object indicates, for example, the direction front of the dummy element (front or face of a human dummy or the front end of a vehicle dummy). The orientation of the object may indicate, for example, the predetermined direction of movement, in particular the direction of forward movement.

Thus, a direction vector of the dummy element may be determined based on the recording of a single image.

According to an exemplary embodiment, the direction pointer represents an arrow such that it has an arrangement of at least two, in particular three, points or has a specific arrangement of at least 2-colored patterns to define the direction of movement.

For example, two points of a marker element may indicate a direction information or an orientation of the marker element and corresponding dummy element based on their distance direction.

According to an exemplary embodiment, the marker element has an information field which is arranged in such a way that it is visible on the recorded image of the monitoring area, the information field being designed such that specific data, in particular of the dummy element, may be read out on the basis of the image of the information field on the recorded image, the information field having in particular a barcode or an identification number.

For example, the information field may comprise information about the type of the dummy element, such as whether the dummy element is a vehicle or a pedestrian. Further, the information field may comprise information about geometric shapes or speeds of the dummy element.

With the present invention, a position determination of a movable dummy element may also be carried out within a roofed test site, i.e. without the reception of GPS data. With the system according to the invention, in particular a position determination of the dummy element as well as likewise a speed and direction determination of the dummy element is possible.

In the position determination, for example, the recording of an image of the monitoring area may be sufficient to determine the exact position of the dummy element in the monitoring area. For this purpose, the position determination unit detects the position of the dummy element in the monitoring area based on the analysis of the recorded image and the marker element discernible thereon. During the analysis, for example, a virtual grid may be superimposed by the position determination unit over the image of the monitoring area, so that the position of the dummy element may be concluded accordingly on the basis of the presence of the marker element in a first grid area.

Furthermore, a further stationary marker element may be arranged in the monitoring area, which is also discernible in the recorded image. Based on the distance and the distance direction of the marker element, which moves along with the dummy element, to the stationary further marker element, the position may also be determined. In addition, it may also be possible to conclude a future position at a certain point in time based on velocity data of the dummy element, which may be obtained for example from a control unit. Furthermore, as described above, the marker element itself may have a direction indicator, which indicates an orientation of the object or a predetermined direction of movement of the marker element, so that a corresponding direction of movement may also be determined based on an image recording.

In addition, a direction of movement and the speed of movement of the dummy element may be determined, for example, on the basis of a plurality of images of the monitoring area recorded at specific times, or time-delayed, without the need for further measurement parameters, for example.

For example, only one marker element is required to determine the position of the dummy object.

It should be noted that the embodiments described herein represent only a limited selection of possible embodiments of the invention. Thus, it is possible to combine the features of individual embodiments in a suitable manner, so that a plurality of different embodiments is to be regarded as obviously disclosed to the person skilled in the art with the embodiments made explicit herein. In particular, some embodiments of the invention are described with device claims and other embodiments of the invention are described with method claims. However, it will immediately become apparent to the person skilled in the art upon reading this application that, unless explicitly stated otherwise, in addition to a combination of features belonging to one type of subject matter of the invention, any combination of features belonging to different types of subject matter of the invention is also possible.

### BRIEF DESCRIPTION OF THE DRAWINGS

In the following, for further explanation and for a better understanding of the present invention, embodiments are described in more detail with reference to the accompanying drawings.

FIGS. 1A to 2B are schematic illustrations of a hall as a roofed test site according to the system according to an exemplary embodiment of the present invention, wherein FIGS. 1A and 2A show side views and FIGS. 1B and 2B show top views of the hall.

FIGS. 3 to 15 are schematic illustrations of marker elements according to exemplary embodiments of the present invention.

FIGS. 16 to 25 are schematic illustrations of dummy elements with marker elements according to exemplary embodiments of the invention.

### DETAILED DESCRIPTION OF EXEMPLARY EMBODIMENTS

The same or similar components in different figures are provided with the same reference numerals. The illustrations in the figures are schematic.

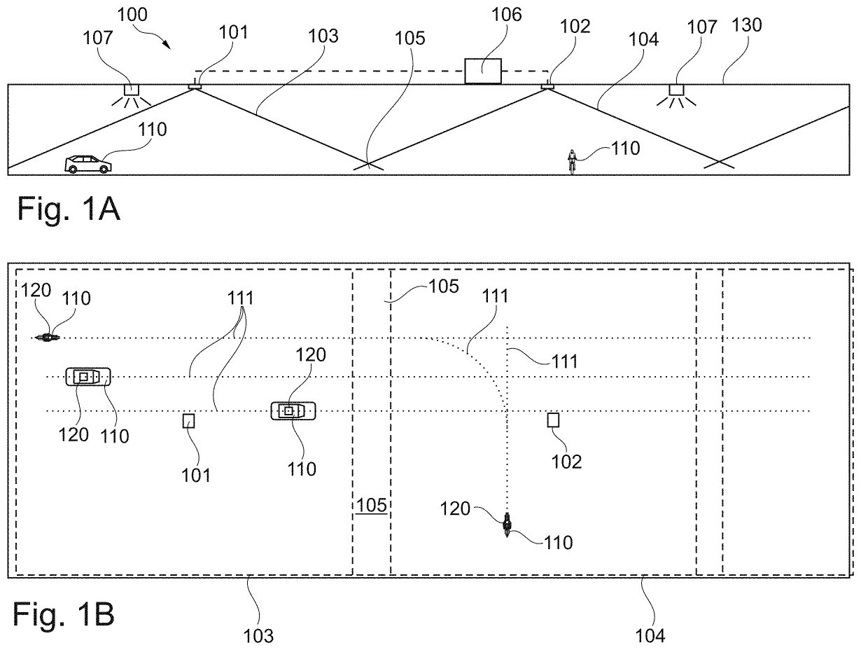

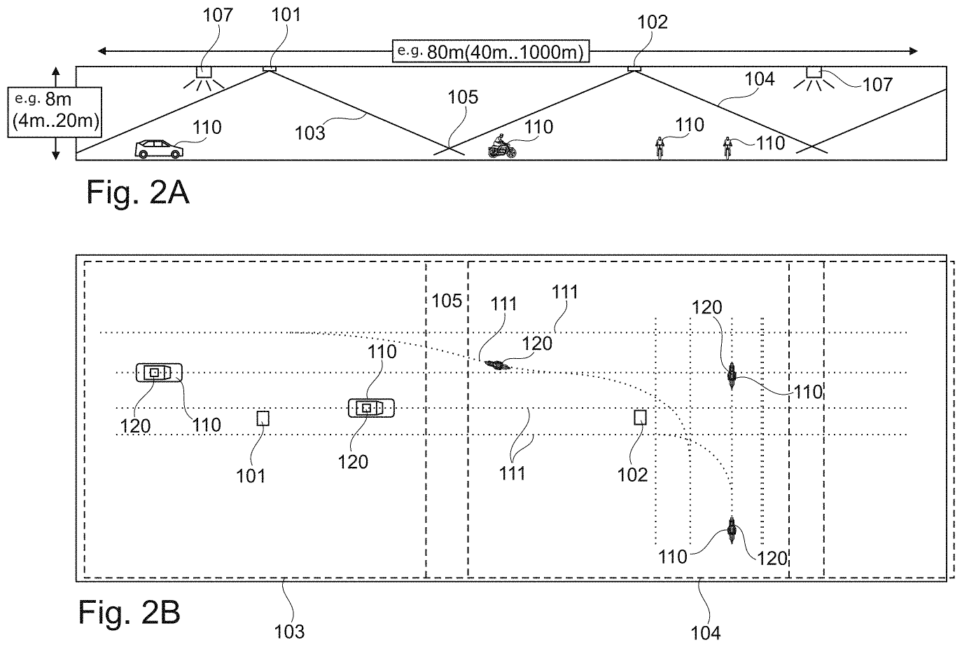

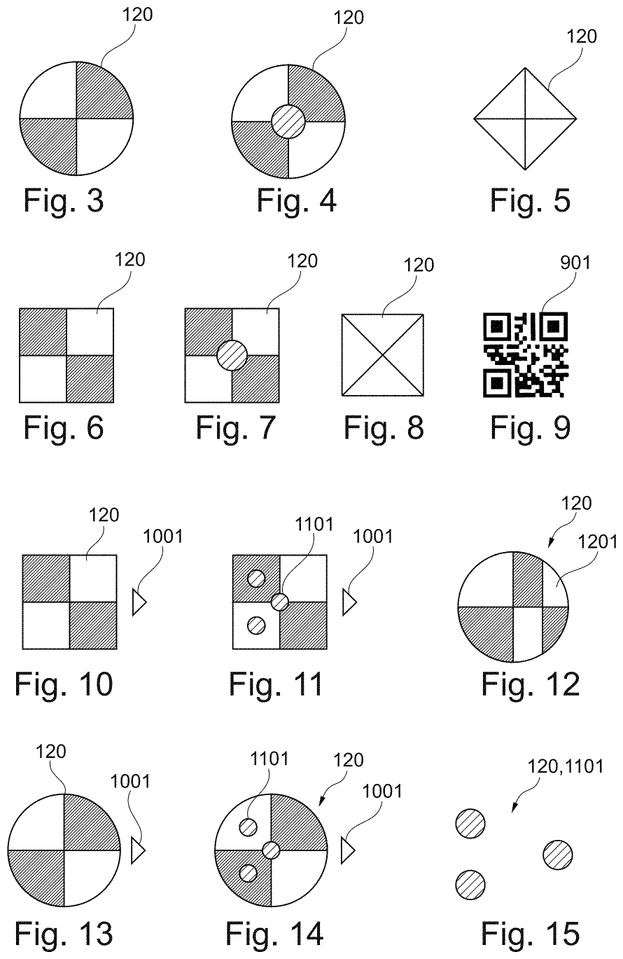

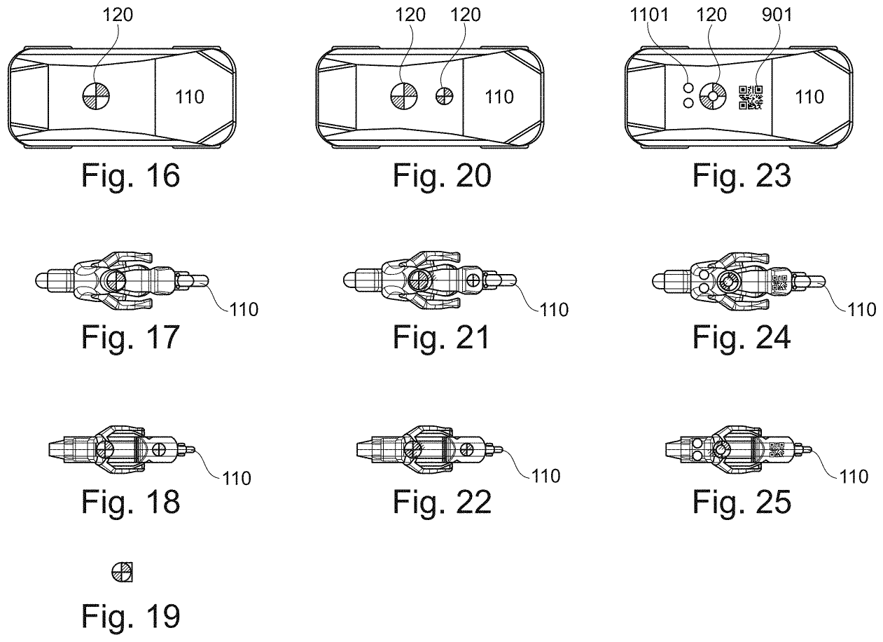

FIGS. 1A to 2B are schematic illustrations of a hall as a roofed test site according to the system 100 according to an exemplary embodiment of the present invention, wherein FIGS. 1A and 2A show side views and FIGS. 1B and 2B show top views of the hall.

The system 100 comprises a camera 101 configured to record an image of a monitoring area 103 of the roofed test site 130, a movable dummy element 110 which may be moved through the monitoring area 103, the dummy element 110 comprising a marker element 120 arranged to be visible on the recorded image of the monitoring area 103, and a position determination unit 106 coupled to the camera 101 and configured to determine the position of the marker element 120 in the monitoring area 102 based on the recorded image.

The system 100 comprises a further camera 102 configured to record an image of a further monitoring area 104 of the roofed test site 130, wherein the position determination unit 106 is coupled to the further camera 102 and configured to determine the position of the marker element 130 in the further monitoring area based on the recorded image of the further camera 102.

The cameras 101, 102 are arranged such that at least one edge region of the monitoring area 103 and a further edge region of the further monitoring area 104 overlap in an overlapping area 105.

According to the figures, a plurality of different dummy elements 110 with corresponding marker elements 120 may be present in the roofed test site 130 and may move along their movement paths 111 accordingly. Based on the recorded images, corresponding positions of the individual dummy elements 110 may be determined.

According to an exemplary embodiment, the position determination unit is configured to determine a collision point of the dummy element with the further dummy element.

Further, the system 100 comprises illumination means 107 for illuminating the monitoring area 103, 104 with electromagnetic radiation, wherein the camera 101, 102 is configured to record, in the image, the electromagnetic radiation by means of which the illumination means 107 illuminates the monitoring area 103, 104.

FIG. 3 to FIG. 15 are schematic illustrations of marker elements according to exemplary embodiments of the present invention.

The marker elements 120 may have a circular or rectangular circumference, with the marker element 120 having particular two color regions, in particular white and black.

FIG. 9 shows a marker element with an information field as a barcode.

In FIG. 10, a marker element is shown which additionally has a direction indicator as an arrow 1001 indicating an orientation of the object.

In FIG. 11, in addition to the direction indicator in the form of an arrow 1001, a direction indicator consisting of three dots 1101 is also shown. Furthermore, a specific arrangement 1201 of at least 2-coloured patterns may be used to define the direction of movement (see FIG. 12).

FIG. 16 to FIG. 25 show schematic illustrations of dummy elements 110 with various marker elements 120 according to exemplary embodiments of the invention.

Supplementally, it should be noted that “comprising” does not exclude other elements or steps and “a” or “an” does not exclude a plurality. It should further be noted that features or steps that have been described with reference to any of the above embodiments may also be used in combination with other features or steps of other embodiments described above. Reference signs in the claims are not to be regarded as a limitation.

### LIST OF REFERENCE SIGNS

100 System
101 Camera
102 further camera
103 Monitoring area
104 further monitoring area
105 Overlapping area
106 Position determination unit
107 Illumination means
110 Dummy element
111 Movement path
120 Marker element
901 Information field
1001 Arrow
1101 Arrangement of three points
1201 Arrangement of 2-coloured patterns

1-20. (canceled)

21. A system for determining the position of movable dummy elements in a rooted test site, the system comprising:
a camera configured to record an image of a monitoring area of the roofed test site,
a movable dummy element, which is movable through the monitoring area,
a marker element which is movable with the dummy element so as to be visible on the recorded image of the monitoring area, and
a position determination unit which is coupled to the camera and is configured to determine the position of the marker element in the monitoring area based on the recorded image.

22. The system according to claim 21,
wherein the marker element is arranged on the dummy element.

23. The system according to claim 21, further comprising
a further marker element which is arranged stationary in the monitoring area such that it is visible on the recorded image of the monitoring area.

24. The system according to claim 21,
wherein the position determination unit is configured to overlay a virtual grid over the image,
where each grid field of the grid is indicative of a particular position in the monitoring area.

25. The system according to claim 24,
wherein a grid field is smaller than 9 cm².

26. The system according to claim 21,
wherein the camera is configured to record a further image after a certain time offset after the image,
wherein the position determination unit is configured to determine a movement speed and movement direction of the marker element based on the recorded image and the further image.

27. The system according to claim 21, further comprising
a further camera which is configured to record an image of a further monitoring area of the roofed test site,
wherein the position determination unit is coupled to the further camera and is configured to determine the position of the marker element in the further monitoring area based on the recorded image of the further camera.

28. The system according to claim 27,
wherein the further monitoring area is positioned adjacent to the monitoring area,
wherein at least one edge region of the monitoring area and a further edge region of the further monitoring area overlap.

29. The system according to claim 21, further comprising
a further movable dummy element which is movable through the monitoring area and/or the further monitoring area,
a further marker element which is movable with the dummy element such that it is visible on the recorded image of the monitoring area or the image of the further monitoring area.

30. The system according to claim 19,
wherein the position determination unit is configured to determine a collision point of the dummy element with the further dummy element.

31. The system according to claim 21,
wherein the dummy element is a two-wheeler, a motorcycle or a bicycle, a motor vehicle, a human dummy or an animal dummy.

32. The system according to claim 21, further comprising a movable platform
wherein the dummy element is arranged on the movable platform.

33. The system according to claim 32,
wherein the marker element is arranged on the platform.

34. The system according to claim 21, further comprising
at least one illumination means for illuminating the monitoring area with electromagnetic radiation,
wherein the camera is configured to record, in the image, the electromagnetic radiation by means of which the illumination means illuminates the monitoring area.

35. The system according to claim 44,
wherein the electromagnetic radiation is generated in the visible spectrum with a wavelength of 380 to 750 nm, or
wherein the electromagnetic radiation is generated in the non-visible spectrum.

36. The system according to claim 21,
wherein the marker element is fluorescent; and/or
wherein the marker element comprises an illuminant, which generates visible light or non-visible light which is recordable by the camera.

37. The system according to claim 21,
where the camera has less than 10 megapixels; and/or
wherein the marker element has a round or rectangular circumference, wherein the marker element comprises particular two color regions.

38. The system according to claim 21,
wherein the marker element comprises a direction indicator which indicates an orientation of the object.

39. The system according to claim 38,
wherein the direction pointer represents an arrow, has an arrangement of at least two points or has a specific arrangement of at least 2-coloured patterns to define the direction of movement.

40. The system according to claim 2,
wherein the maker element comprises an information field arranged to be visible on the recorded image of the monitoring area,
wherein the information field is designed such that specific data can be read out on the basis of the image of the information field on the recorded image.
